(19) United States
(12) Patent Application Publication
(10) Pub. No.: US 2014/0290143 A1
(43) Pub. Date: Oct. 2, 2014

(54) OPENING TRIM WEATHERSTRIP

(71) Applicant: TOYODA GOSEI CO., LTD., Kiyosu-shi (JP)

(72) Inventors: Yoshinobu YAMADA, Kiyosu-shi (JP); Yasuhiro SHIMIZU, Kiyosu-shi (JP); Mitsunobu TERAMOTO, Kiyosu-shi (JP); Daisuke SAKAI, Kiyosu-shi (JP); Hirofumi OTSUKA, Kiyosu-shi, Aichi-ken (JP)

(73) Assignee: TOYODA GOSEI CO., LTD., Kiyosu-shi (JP)

(21) Appl. No.: 14/174,949

(22) Filed: Feb. 7, 2014

(30) Foreign Application Priority Data
Mar. 29, 2013 (JP) 2013-072699

(51) Int. Cl. B60J 10/00; E06B 7/23

(52) U.S. Cl. CPC B60J 10/0031; E06B 7/2314; B60J 10/0002
USPC 49/490.1; 49/498.1

(57) ABSTRACT

An opening trim weatherstrip includes an attaching base portion that is attached to a flange formed on a vehicle body opening peripheral edge and a hollow seal portion that is provided integrally on the attaching base portion and is abutted to an outer periphery of a door frame or a door panel of a vehicle door to seal a gap between the vehicle door and the vehicle body opening peripheral edge. The hollow seal portion includes a proximal hollow portion and a distal hollow portion. The distal hollow portion includes a first distal hollow seal wall and a second distal hollow seal wall. The first distal hollow seal wall is formed in a curved surface with a curvature radius of 20 to 80 mm.

### CROSS REFERENCE TO RELATED APPLICATION

This application is based on Japanese Patent Application No. 2013-072699 filed on Mar. 29, 2013, the contents of which are incorporated herein by reference.

### BACKGROUND OF THE INVENTION

1. Technical Field

The present invention relates to an opening trim weatherstrip for a vehicle, adapted to seal a gap between a vehicle door and a vehicle body opening peripheral edge.

2. Background Art

Conventionally, sealing between a vehicle door and a vehicle body opening peripheral edge is obtained by a glass run (not shown) attached to a channel (not shown) on an inner periphery of a door frame 2 of the door, an opening weatherstrip (not shown) attached in the vicinity of an opening of the vehicle body opening peripheral edge 6, and an opening trim weatherstrip 110, as described below, attached to a flange 7 of the vehicle body opening peripheral edge 6.

As shown in FIGS. 2 and 3, the opening trim weatherstrip 110 is formed as one unit by extrusion molding, and after two ends thereof are connected by a connector 111 to form an annular shape, is attached to the substantially entire periphery of the vehicle body opening peripheral edge 6 of the vehicle body, so that when the door is closed, the opening trim weatherstrip 110 is abutted to an outer periphery of the door frame 2 or a door panel, thereby providing sealing, As shown in FIG. 4, the vehicle body opening peripheral edge 6 is provided with the flange 7 and the opening trim weatherstrip 110 is attached to the flange 7. The flange 7 is formed by fixedly welding distal ends of an inner panel 8 and an outer panel 9 to each other.

As shown in FIG. 4, the opening trim weatherstrip 110 has a hollow seal portion 130 and an attaching base portion (trim portion) 120 of a generally U shape in cross section, and is attached to the flange 7 by the attaching base portion (trim portion) 120. The trim portion 120 is formed by a vehicle outside sidewall 121, a vehicle inside sidewall 122 and a bottom wall 123, and thus has a generally U shape in cross section (e.g., see JP-T-2001-513050). The term JP-T as used herein means a published Japanese translation of a PCT patent application.

As shown in FIG. 4, on an inner surface of each of the vehicle outside sidewall 121 and the vehicle inside sidewall 122 in the generally U shape in cross section, a vehicle outside holding lip 124 and a vehicle inside holding lip 125 are respectively formed to hold the flange 7. When the flange 7 is inserted in the trim portion 120, distal ends of the vehicle outside holding lip 124 and the vehicle inside holding lip 125 are bent and thus pressed against either side surface of the flange 7 to hold the flange 7, thereby attaching the opening trim weatherstrip 110.

Also, the hollow seal portion 130 is abutted to the door frame 2, thereby sealing between the door and the vehicle body.

However, because an abutted portion between the hollow seal portion 130 and the door frame 2 is small, there is a case that sealing is not sufficient when the door is a slide door, which is moved in a lateral direction.

In addition, as shown in FIG. 5, there is a technique in which a trim portion 220 is provided with a hollow seal portion 230 having two hollow portions and the hollow seal portion 230 is abutted to a door frame 2 to provide sealing (e.g., see JP-A-2005-119350). In this case, an outer surface 231 of the seal portion abutted to the door frame 2 is formed to become a curved surface, and the door frame 2 pushes down the hollow seal portion 230 while sliding on the curved surface of the hollow seal portion 230 to provide sealing.

However, in this case, if a curvature radius of the curved surface is small and the door is a slide door, which is moved in a lateral direction, and the like, there is a case that, because the door frame 2 is slid on the curved surface of the hollow seal portion 230, a sealing point, which is an abutted portion between the door frame 2 and the curved surface of the hollow sealing portion 230, is deviated, thereby decreasing sealing ability.

Accordingly, an object of the present invention is to provide an opening trim weatherstrip for a vehicle, in which even if a position of a door is misaligned, sealing ability can be ensured.

### SUMMARY OF THE INVENTION

(1) According to an aspect of the invention, an opening trim weatherstrip includes an attaching base portion that is attached to a flange formed on a vehicle body opening peripheral edge and a hollow seal portion that is provided integrally on the attaching base portion and is abutted to an outer periphery of a door frame or a door panel of a vehicle door to seal a gap between the vehicle door and the vehicle body opening peripheral edge. The hollow seal portion includes a proximal hollow portion integrally formed with the attaching base portion and a distal hollow portion integrally formed with the proximal hollow portion. The distal hollow portion includes a first distal hollow seal wall located on a side to be abutted to the outer periphery of the door frame or the door panel and a second distal hollow seal wall located at a vehicle interior side of the distal hollow portion. The first distal hollow seal wall is formed in a curved surface with a curvature radius of 20 to 80 mm.

With the configuration of (1), the opening trim weatherstrip includes an attaching base portion adapted to be attached to the flange, and a hollow seal portion provided integrally on the attaching base portion and adapted to he abutted to an outer periphery of a door frame or a door panel of the vehicle door for sealing between the vehicle door and the vehicle body opening peripheral edge. Therefore, because the hollow seal portion is formed in a hollow shape when the attaching base portion is attached to the flange, the hollow seal portion can be securely abutted to the outer periphery of the door frame or the door panel even if there is a variation in mounting of the door, thereby sealing between the outer periphery of the door frame or the door panel and the vehicle body opening peripheral edge.

The hollow seal portion is formed by a proximal hollow portion integrally formed with the attaching base portion, and a distal hollow portion integrally formed with the proximal hollow portion. Therefore, a size of a hollow portion inside the hollow seal portion can be divided into two, so that a size of each of the resulted hollow portions is small, thereby decreasing deformation of the hollow portions. Thus, when the opening trim weatherstrip is attached in corner portions, the hollow seal portion is hardly fallen down, thereby ensuring the sealing ability.

The distal hollow portion is constituted of a first distal hollow seal wall located on a side to be abutted to the outer periphery of the door frame or the door panel, and a second distal hollow seal wall located on the vehicle inside, and the first distal hollow seal wall is formed in a curved surface. Therefore, when being abutted to the outer periphery of the door frame or the door panel, the distal hollow portion is smoothly abutted thereto, and also, the curved surface portion thereof is abutted thereto in a linear contact manner, thereby ensuring a contact pressure. Thus, sealing in a linear seal manner can be obtained, thereby ensuring the sealing ability.

Because the surface of the first distal hollow seal wall has a curvature radius of 20 to 80 mm, the curvature radius is large. Therefore, when the first distal hollow seal wall is abutted to the outer periphery of the door frame or the door panel, a portion to be contacted with the surface is smooth and is not largely deviated even if the door is vibrated or misaligned, thereby ensuring the sealing ability.

If the curvature radius is smaller than 20 mm, an outer shape of the first distal hollow seal wall is close to a circular arc, and therefore, when the door is closed, a triangular gap generated between the door frame or the door panel and the hollow seal portion is increased, so that rainwater is likely to be accumulated therein. Therefore, the rainwater is entered through between the door frame or the door panel and the first distal hollow seal wall, causing water leakage.

Also, a distance between the vehicle body opening peripheral edge and the door frame or the door panel can be changed due to vibration of the door during driving of the vehicle. At this time, if the curvature radius of the surface of the first distal hollow seal wall is smaller than 20 mm, a contact area between the first distal hollow seal wall and the door frame or the door panel is reduced, and in particular, when the distance between the vehicle body opening peripheral edge and the door frame or the door panel is increased, there is a case that the door and the hollow seal portion are spaced apart from each other so that an abutted location therebetween is deviated, thereby decreasing the sealing ability.

If the curvature radius is larger than 80 mm, the circular arc of the first distal hollow seal wall becomes excessively larger, and thus a hollow shape cannot be formed.

(2) In the configuration of (1), the proximal hollow portion includes a first proximal hollow seal wall located at amide to be abutted to the outer periphery of the door frame or the door panel and a second proximal hollow seal wall located at the vehicle interior side, and wherein the first distal hollow seal wall of the distal hollow portion and the first proximal hollow seal wall of the proximal hollow portion form a smoothly continued curved surface together.

With the configuration of (2), the proximal hollow portion is constituted of a first proximal hollow seal wall located on a side to be abutted to the outer periphery of the door frame or the door panel, and a second proximal hollow seal wall located on the vehicle inside, and the first distal hollow seal wall of the distal hollow portion and the first proximal hollow seal wall of the proximal hollow portion are formed in a smoothly continued curved surface. Therefore, because the first distal hollow seal wall and the first proximal hollow seal wall form the smoothly curved surface, a continuous sealing ability against the outer periphery of the door frame or the door panel can be ensured even if the door is misaligned,

(3) In the configuration of (1) or (2), a bridge seal wall is formed between the proximal hollow portion and the distal hollow portion.

With the configuration of (3), because a bridge seal wall is formed between the proximal hollow portion and the distal hollow portion, rigidity of the hollow seal portion can be enhanced, and when the outer periphery of the door frame or the door panel is abutted to the hollow seal portion, the bridge seal wall can prevent an abnormal deformation, thereby ensuring the sealing ability.

(4) In the configuration of any one of (1) to (3), the first distal hollow seal wall and the second distal hollow seal wall of the distal hollow portion have a thickness of 1.5 to 2.5 mm.

With the configuration of (4), because the first distal hollow seal wall and the second distal hollow seal wall of the distal hollow portion have a thickness of 1.5 to 2.5 mm, the distal hollow portion has flexibility and elasticity, and therefore, when the outer periphery of the door frame or the door panel is abutted thereto, the distal hollow portion is not abnormally deformed, and also has a sufficient contact load against the outer periphery of the door frame or the door panel, thereby ensuring the sealing ability.

(5) In the configuration of any one of (1) to (3), the attaching base portion includes a vehicle outside sidewall, a vehicle inside sidewall and a bottom wall and is formed in a generally U shape in cross section by the vehicle outside sidewall, the vehicle inside sidewall and the bottom wall.

With the configuration of (5), because the attaching base portion is constituted of a vehicle outside sidewall, a vehicle inside sidewall and a bottom wall, and thus is formed in a generally U shape in cross section, the flange can he held in the interior thereof having a generally U shape in cross section, and thus can be firmly sandwiched by a vehicle outside holding lip and a vehicle inside holding lip formed inside the vehicle outside sidewall and the vehicle inside sidewall.

(6) In the configuration of any one of (1) to (5), the attaching base portion is formed of a solid material or a fine foamed material, and the hollow seal portion is formed of a sponge material having a specific gravity of 0.5 to 0.7.

With the configuration of (6), because the attaching base portion is formed of a solid material or a fine foamed material, the hollow seal portion can be securely held, and also a force for sandwiching the flange can be strong to stably hold the flange.

Because the hollow seal portion is formed of a sponge material having a specific gravity of 0.5 to 0.7, the hollow seal portion has flexibility, and therefore, can be abutted to follow a variation of the shape of the vehicle door, thereby ensuring the sealing ability. Also, the overall weight of the opening trim weatherstrip is reduced, thereby contributing to reducing a weight of the vehicle.

(7) In the configuration of any one of (1) to (6), the opening trim weatherstrip is attached to the vehicle body opening peripheral edge for a slide door.

With the configuration of (7), because the opening trim weatherstrip is attached to the vehicle body opening peripheral edge of a slide door, even if a location abutted to the opening trim weatherstrip is deviated when the slide door is vibrated during driving or when the door is closed, the door can be securely abutted to a desired location on the hollow seal portion, thereby providing sealing.

Because the distal hollow portion is constituted of a first distal hollow seal wall and a second distal hollow seal wall, and the first distal hollow seal wall is formed in a curved surface, when being abutted to the outer periphery of the door frame or the door panel, the distal hollow portion is smoothly abutted thereto, and also, the curved surface portion thereof is abutted thereto in a linear contact manner, thereby ensuring a contact pressure. Thus, sealing in a linear seal manner can be obtained, thereby ensuring the sealing ability.

Because the surface of the first distal hollow seal wall has a curvature radius of 20 to 80 mm, when the first distal hollow seal wall is abutted to the outer periphery of the door frame or the door panel, a portion to be contacted with the surface is not largely deviated even if the door is vibrated or misaligned, thereby ensuring the sealing ability.

### BRIEF DESCRIPTION OF THE DRAWINGS

FIG. 1 is a sectional view showing a state where an opening trim weatherstrip according to an embodiment of the present invention is attached to a flange.

FIG. 2 is aside view of a vehicle having a slide door.

FIG. 3 is a front view of a door opening trim weatherstrip according to an embodiment of the present invention.

FIG. 4 is a sectional view showing a state where a door opening trim weatherstrip according to the related art is attached to a peripheral edge of an opening portion of a vehicle.

FIG. 5 is a sectional view showing a state where another door opening trim weatherstrip according to the related art is attached to a peripheral edge of an opening portion of a vehicle.

### DESCRIPTION OF PREFERRED EMBODIMENT

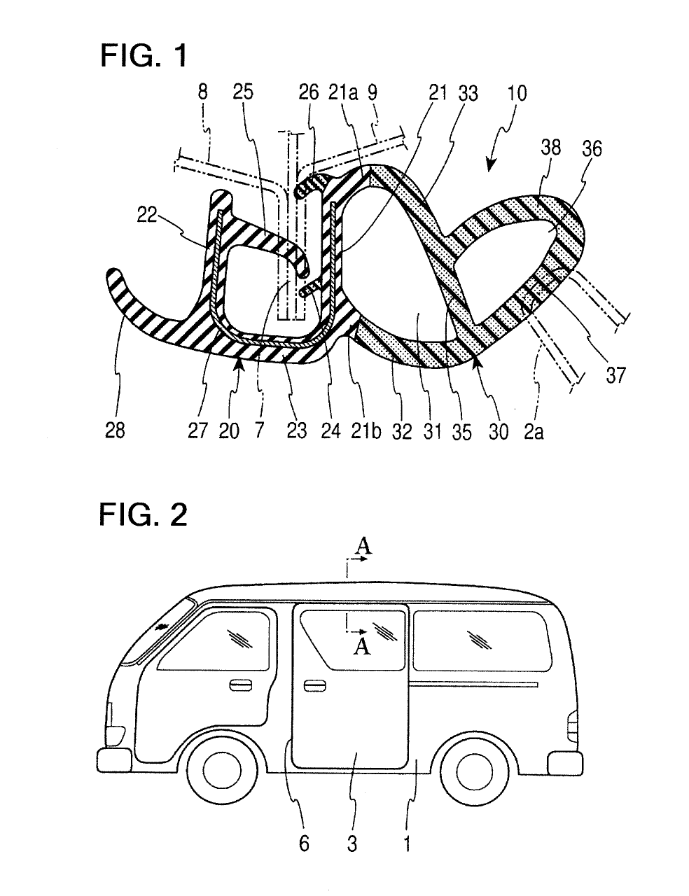

Embodiments of the present invention will be described with reference to FIGS. 1 to 3.

As shown in FIG. 2, a vehicle body 1 has a door opening portion, and the door opening portion is closed by a door 3, which is an opening and dosing member. The door opening portion has a vehicle body opening peripheral edge 6 formed on a peripheral thereof, and the vehicle body opening peripheral edge 6 has a flange 7 (see FIGS. 1 and 2), on which distal ends of an outer panel 9, an inner panel 8 and the like constituting the vehicle body 1 are welded. The number of panels in the flange 7 can be varied from 2 sheets to 8 sheets, depending on a location on the vehicle body opening peripheral edge 6 of the vehicle body 1.

A sealing between the door 3 and the vehicle body opening peripheral edge 6 is obtained by a glass run (not shown) attached to a channel of the door 3 for sealing between a door glass 5 and an inner periphery of a door frame 2, an opening weatherstrip (not shown) for sealing an opening side of the vehicle body opening peripheral edge 6, and an opening trim weatherstrip 10 attached to the flange 7 for sealing an inner side of the vehicle than the opening weatherstrip.

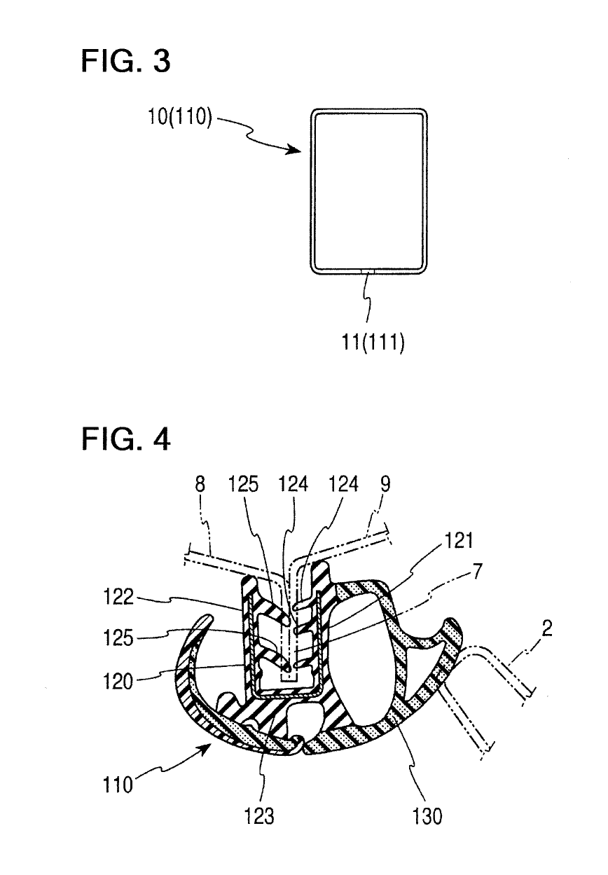

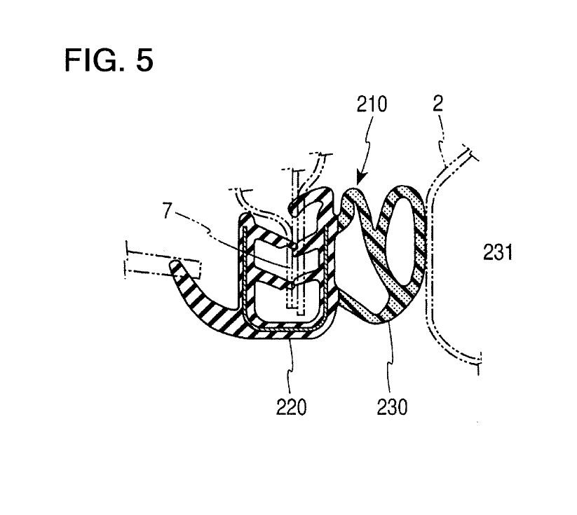

The present invention relates to the opening trim weatherstrip 10. The opening trim weather strip 10 is formed in a straight line shape by extrusion molding. One opening trim weatherstrip 10 formed in the straight line shape, as shown in FIG. 3, is mounted on the flange 7 to have an annular shape along a shape of the vehicle body opening peripheral edge 6.

Mounting is obtained by mounting in order from one end of the opening trim weatherstrip 10 to the other end on the flange 7, and after mounting is completed, the other end is bonded with the one end. These ends may be mold-bonded to each other by a connector 11, thereby forming the annular shape.

In addition, before mounting, the ends of the opening trim weatherstrip 10 may be adhered to each other by adhesives, thereby forming the annular shape.

As shown in FIG. 1, the opening trim weatherstrip 10 includes a trim portion (attaching base portion) 20 of a generally U shape in cross section adapted to be attached to the flange 7, and a hollow seal portion 30 of a hollow shape formed integrally with the trim portion 20 and adapted to he abutted to a door frame protrude 2a of the door frame 2, thereby serving as a seal portion for sealing between the door and the vehicle body opening peripheral edge 6. The embodiments of the present invention will he described, as an example, with respect to the opening trim weatherstrip 10 abutted to the door frame 2 for a slide door. The present invention may be also applied to the opening trim weatherstrip 10 to be used in door opening portions other than the slide door.

According to the present invention, the hollow seal portion 30 is integrally provided on an outer surface of a vehicle outside sidewall 21 of the trim portion 20. The hollow seal portion 30 will be described below.

In the present embodiment, although the trim portion 20 of a generally U shape in cross section is described as an example of the attaching base portion, the attaching base portion may be any of those capable of attaching to the flange 7, and accordingly, for example, a flat-plate-shaped attaching base portion may be attached by a clip, a double-sided adhesive tape, or the like.

The trim portion 20 is constituted of the vehicle outside sidewall 21, a vehicle inside sidewall 22 and a bottom wall 23, and is formed in a generally U shape in cross section. An insert member 27 is embedded in the trim portion 20 to increase strength for gripping the flange 7. The insert member 27 is made of a sheet metal or a hard resin, and is formed in a ladder shape, a fish bone shape, a zigzag shape or the like to ensure flexibility required when being attached in corner portions. The trim portion 20 is formed of a solid material or a fine-foamed material. Alternatively, when the trim portion 20 is formed by a hard member, the insert member 27 may not be used.

On inner surfaces of the vehicle outside sidewall 21 and the vehicle inside sidewall 22, a vehicle outside holding lip 24 and a vehicle inside holding lip 25, which extend along a longitudinal direction of the opening trim weatherstrip 10 and sandwich the flange 7 therebetween, are respectively formed. Therefore, the distal end of each of the vehicle outside holding lip 24 and the vehicle inside holding lip 25 is abutted to each of both side surfaces of the flange 7, thereby firmly holding the flange 7. Thus, the trim portion 20 is not displaced and the hollow seal portion 30 is securely abutted to the door frame 2, thereby ensuring a sealing ability.

According to the present embodiment, one vehicle inside holding lip 25 is formed to be long in length. Therefore, the vehicle inside holding lip 25 can stably hold the flange 7, because the vehicle inside holding lip 25 is bent and thus the flange 7 is pressed against the vehicle outside sidewall 21 even if a thickness of the flange 7 is varied. The distal end of the vehicle inside holding lip 25 is formed to be bent in a direction toward the bottom wall 23 and thus to easily hold the flange 7.

According to the present embodiment, the vehicle outside holding lip 24 is formed to be short in length, and one vehicle inside holding lip 25 is formed to be long in length and also to protrude in an oblique direction into the interior having a generally U shape in cross section. Therefore, the flange 7 is located on the inner surface side of the vehicle outside sidewall 21 and is held by the vehicle outside holding lip 24. In addition, the vehicle outside holding lip 24 and the vehicle inside holding lip 25 can securely follow unevenness or bending of the flange 7 and be abutted to the flange 7, thereby ensuring the sealing ability.

According to the present embodiment, one vehicle outside holding lip 24 is formed, but a plurality of vehicle outside holding lips 24 may be formed.

A cover lip 28 extends from a continuous portion between the vehicle inside sidewall 22 and the bottom wall 23 in a vehicle inward direction, and covers a distal end of a garnish (not shown) attached inside the vehicle.

A vehicle outside seal lip 26, which is abutted to the flange 7, is provided on a distal end of the vehicle outside sidewall 21. As shown in FIG. 1, if the trim portion 20 is attached to the flange 7, the vehicle outside seal lip 26 is abutted to a proximal portion of the flange 7 to close a gap between the outer panel 9 and the vehicle outside sidewall 21, thereby preventing rainwater flowed in through the outer panel 9 from being entered into the vehicle interior through between the outer panel 9 and the vehicle outside sidewall 21.

Next, the hollow seal portion 30, which is a seal portion, will he described.

On an outer surface of the vehicle outside sidewall 21 of the trim portion 20, the hollow seal portion 30 is integrally formed therewith. The hollow seal portion 30 is constituted of a proximal hollow portion 31 integrally formed with the vehicle outside sidewall 21 of the trim portion 20, which is the attaching base portion, and a distal hollow portion 36 integrally formed with the proximal hollow portion 31.

A hollow portion formed inside the hollow seal portion 30 is divided into two by a bridge seal wall 35 and a size of each of the resulted hollow portions becomes small, thereby decreasing deformation of the hollow portions. Also, by the bridge seal wall 35, rigidity of the hollow seal portion 30 is enhanced, and when an outer periphery of the door frame 2 or the door panel is abutted to the hollow seal portion 30, the bridge seal wall 35 can prevent an abnormal deformation of the hollow seal portion 30, thereby ensuring the sealing ability. In addition, when the opening trim weatherstrip 10 is attached in the corner portions of the vehicle body opening peripheral edge 6, the hollow seal portion 30 is hardly displaced from suitable position, thereby ensuring the sealing ability.

The proximal hollow portion 31 is constituted of a first proximal hollow seal wall 32 located on a side to he abutted to the outer periphery of the door frame 2 or the door panel, and a second proximal hollow seal wall 33 located on the vehicle inside, and has a hollow portion surrounded by the vehicle outside sidewall 21 and the bride seal wall 35, which connects a distal end of each of the first proximal hollow seal wall 32 and the second proximal hollow seal wall 33 to each other.

The distal hollow portion 36 is constituted of a first distal hollow seal wall 37 located on a side to be abutted to the outer periphery of the door frame 2 or the door panel, and a second distal hollow seal wall 38 located on the vehicle inside. Proximal sides of the first distal hollow seal wall 37 and the second distal hollow seal wall 38 are formed from side ends of the bridge seal wall 35, and distal ends of the first distal hollow seal wall 37 and the second distal hollow seal wall 38 are continued to each other, so that the bridge seal wall 35, the first distal hollow seal wall 37 and the second distal hollow seal 38 define a hollow portion of a generally triangle shape in cross section.

The first distal hollow seal wall 37 is formed in a curved surface. Therefore, when the distal hollow portion 36 is abutted to the outer periphery of the door frame 2 or the door panel, the distal hollow portion 36 is smoothly abutted to the door frame 2 or the door panel, and also, the curved surface portion of the first distal hollow seal wall 37 is abutted to the door frame 2 or the door panel in a linear contact manner, thereby ensuring a contact pressure. Thus, sealing in a linear seal manner can be obtained and the sealing ability is ensured.

The curved surface of the first distal hollow seal wall 37 is formed to have a curvature radius of 20 to 80 mm. In the present embodiment, the curvature radius is 50 mm. Therefore, when the first distal hollow seal wall 37 is abutted to the outer periphery of the door frame 2 or the door panel, a portion to be contacted with the surface is not largely deviated even if the door is vibrated or misaligned, thereby ensuring the sealing ability.

If the curvature radius of the surface of the first distal hollow seal wall 37 is smaller than 20 mm, an outer shape of the first distal hollow seal wall 37 is close to a circular arc, and therefore, when the door is closed, a triangular gap generated between the door frame 2 or the door panel and the hollow seal portion 30 is increased, so that rainwater is likely to be accumulated therein. Therefore, the rainwater is entered through between the door frame 2 or the door panel and the first distal hollow seal wall 37, causing water leakage.

Also, a distance between the vehicle body opening peripheral edge and the door frame 2 or the door panel can be changed due to vibration of the door during driving of the vehicle. At this time, if the curvature radius of the surface of the first distal hollow seal wall 37 is smaller than 20 mm, a contact area between the first distal hollow seal wall 37 and the door frame 2 or the door panel is reduced, and in particular, when the distance between the vehicle body opening peripheral edge and the door frame 2 or the door panel is increased, there is a case that the door and the hollow seal portion 30 are spaced apart from each other so that an abutted location therebetween is deviated, thereby decreasing the sealing ability.

If the curvature radius of the surface of the first distal hollow seal wall 37 is larger than 80 mm, the circular arc of the first distal hollow seal wall 37 becomes excessively larger, and thus a hollow shape cannot be formed.

Preferably, the first distal hollow seal wall 37 of the distal hollow portion 36 and the first proximal hollow seal wall 32 of the proximal hollow portion 31 are preferably formed in a smoothly continued curved surface. By such a configuration, a continuous sealing ability against the outer periphery of the door frame 2 or the door panel can be ensured even if the door is misaligned.

Preferably, the first distal hollow seal wall 37 and the second distal hollow seal wall 38 of the distal hollow portion 36 have a thickness of 1.5 to 2.5 mm. By such a configuration, because the distal hollow portion 36 has flexibility and elasticity, when the outer periphery of the door frame 2 or the door panel is abutted to the distal hollow portion 36, the distal hollow portion 36 is not abnormally deformed, and also has a sufficient contact load against the outer periphery of the door frame 2 or the door panel, thereby ensuring the sealing ability. Meanwhile, in the present embodiment, the first distal hollow seal wall 37 and the second distal hollow seal wall 38 have a thickness of about 2 mm.

In the present invention, the trim portion 20 is preferably formed of a solid material or a fine-roamed material. In this case, the trim portion 20 can be adapted such that a force for sandwiching the flange 7 is strong to stably hold the flange 7, and also can securely hold the hollow seal portion 30, thereby ensuring the sealing ability.

The hollow seal portion 37 is preferably formed of a sponge material having a specific gravity of 0.5 to 0.7. In this case, the hollow seal portion 30 has flexibility, and therefore, the hollow seal portion 30 can be abutted to follow a variation of the shape of the vehicle door, thereby ensuring the sealing ability. Also, the overall weight of the opening trim weatherstrip 10 is reduced, thereby contributing to reducing a weight of the vehicle.

Hereinafter, a method of manufacturing the opening trim weatherstrip 10 will be described.

The opening trim weatherstrip 10 is formed by extrusion molding. A solid rubber or a fine-foamed material for the trim portion 20, the insert member 27, and a sponge rubber for the hollow seal portion 30 is integrally extruded by an extrusion molding machine.

Next, in a case that the solid rubber is used, vulcanization is performed by a conventional method. Then the opening trim weatherstrip 10 is cut into a predetermined length corresponding to one unit.

What is claimed:

1. An opening trim weatherstrip comprising:
an attaching base portion that is attached to a flange formed on a vehicle body opening peripheral edge; and
a hollow seal portion that is provided integrally on the attaching base portion and is abutted to an outer periphery of a door frame or a door panel of a vehicle door to seal a gap between the vehicle door and the vehicle body opening peripheral edge,
wherein the hollow seal portion includes a proximal hollow portion integrally formed with the attaching base portion and a distal hollow portion integrally formed with the proximal hollow portion,
wherein the distal hollow portion includes a first distal hollow seal wall located on a side to he abutted to the outer periphery of the door frame or the door panel and a second distal hollow seal wall located at a vehicle interior side of the distal hollow portion, and
wherein the first distal hollow seal wall is formed in a curved surface with a curvature radius of 20 to 80 mm.

2. The opening trim weatherstrip according to claim 1, wherein the proximal hollow portion includes a first proximal hollow seal wall located at a side to be abutted to the outer periphery of the door frame or the door panel and a second proximal hollow seal wall located at the vehicle interior side, and
wherein the first distal hollow seal wall of the distal hollow portion and the first proximal hollow seal wall of the proximal hollow portion form a smoothly continued curved surface together.

3. The opening trim weatherstrip according to claim 1, wherein a bridge seal wall is formed between the proximal hollow portion and the distal hollow portion.

4. The opening trim weatherstrip according to claim 1, wherein the first distal hollow seal wall and the second distal hollow seal wall of the distal hollow portion have a thickness of 1.5 to 2.5 mm.

5. The opening trim weatherstrip according to claim 1, wherein the attaching base portion includes a vehicle outside sidewall, a vehicle inside sidewall and a bottom wall and is formed in a generally U shape in cross section by the vehicle outside sidewall, the vehicle inside sidewall and the bottom wall.

6. The opening trim weatherstrip according to claim 1, wherein the attaching base portion is formed of a solid material or a fine foamed material, and the hollow seal portion is formed of a sponge material having a specific gravity of 0.5 to 0.7.

7. The opening trim weatherstrip according to claim 1, wherein the opening trim weatherstrip is attached to the vehicle body opening peripheral edge for a slide door.
